(19) United States
(12) Patent Application Publication
(10) Pub. No.: US 2002/0124107 A1
(43) Pub. Date: Sep. 5, 2002

(54) Vlan advertisement protocol (VAP)

(76) Inventor: Michele Goodwin, Westlake Village, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/028,647

(22) Filed: Dec. 19, 2001

Related U.S. Application Data
(60) Provisional application No. 60/256,829, filed on Dec. 19, 2000.

(51) Int. Cl. G06F 15/173

(52) U.S. Cl. 709/242

(57) ABSTRACT

VLAN Advertisement Protocol (VAP) is provided to a communication network as an inter-switch VLAN communication protocol. VAP is used to synchronize the VLAN membership databases stored on a switch to be synchronized with other switches in the network. VAP also provides a mechanism for automatically discovering other network nodes.

### CROSS REFERENCE TO RELATED APPLICATION(S)

This application claims priority of U.S. Provisional Patent Application No. 60/256,829 entitled “VLAN Advertisement Protocol,” filed on Dec. 19, 2000, the contents of which are hereby incorporated by reference.

### FIELD OF THE INVENTION

The present invention is related to network communications, and particularly to a system and method for VLAN (Virtual Local Area Network) Advertisement Protocol (VAP).

### BACKGROUND OF THE INVENTION

Communication networks typically comprise multiple switches, each of which maintains its own database of VLAN membership and network devices coupled to it. Because of the independent nature of maintaining databases in each switch, it is often difficult for a switch to become aware of network devices that are coupled to other switches. This lack of awareness of remote devices on the part of the switches often cause unnecessary traffic on the network, for example, through flooding. Further, loss of connectivity to one or more devices may occur when these devices time out, where the VLAN flooding domain has been reduced to not include once included switches.

### SUMMARY

In an exemplary embodiment according to the present invention, a communication network is provided. The communication network includes at least two switches, each switch being capable of maintaining a database of VLAN membership. The communication network also includes a backbone network interconnecting the switches, and at least one network node coupled to at least one of the switches. The VLAN membership databases in said at least two switches are synchronized with one another.

In another exemplary embodiment according to the present invention, a communication network is provided. The communication network includes at least two switches, each switch being capable of maintaining a MAC table. The communication network also includes a backbone network interconnecting the switches, and at least one network node coupled to at least one of the switches. Said at least two switches exchange MAC information, wherein at least one switch uses the MAC information from at least one other switch to update its MAC table.

In yet another exemplary embodiment according to the present invention, a method of updating a VLAN database is provided, comprising: transmitting at least one update message from a first switch; receiving said at least one update message at a second switch; checking at least one entry in said at least one update message against the VLAN database in the second switch; and if a new entry is found, updating the VLAN database with the new entry.

### BRIEF DESCRIPTION OF THE DRAWINGS

FIG. 1 is a system diagram of a communication network, which may be used to implement an exemplary embodiment according to the present invention;

FIG. 2 illustrates a communication network, which may be used to implement VAP;

FIG. 3 illustrates a communication network, which may be used to implement VAP in another exemplary embodiment according to the present invention;

FIG. 4 is a system diagram of an FDDI backbone-based communication network, which may be used to implement an exemplary embodiment according to the present invention;

FIG. 5 is a flow diagram illustrating process of processing VAP updates in an exemplary embodiment according to the present invention; and

FIG. 6 illustrates a generation of adjacency tables used in VAP in an exemplary embodiment according to the present invention.

### DETAILED DESCRIPTION

In an exemplary embodiment according to the present invention, a VLAN Advertisement Protocol (VAP) is provided. The VAP is an inter-switch VLAN communication protocol. VAP in the exemplary embodiment provides that the VLAN membership databases stored on any individual switch are synchronized with other switches within a network, and provides a mechanism for automatically discovering other network nodes. The network nodes may also be referred herein as devices, network devices, nodes, endstations, hosts or any other designation that may be adopted by those skilled in the art.

VAP may be used to advertise connectivity of devices across a network. For example, VAP is used to advertise devices within a VLAN across a portion of a network, for example a backbone.

Membership in VLANs in the exemplary embodiment may be determined by applying policy to a specific traffic, and the policies may be configured. VLAN membership may be detected by a function within the switch called source learning (e.g., L2 source learning). The source learning function may apply the VLAN policies during processing of all unknown unicast, broadcast, and multicast frames.

In the exemplary embodiment, the source learning function and VAP maintain separate databases containing MAC addresses of devices and their VLAN membership attributes. These databases may be updated real-time, so that forwarding of all traffic may be based on the most recent information. Therefore, a user may have an option to disable the exchange of VLAN information (using VAP), and still have the auto-discovery capability active (e.g., using the source learning function).

VAP in the exemplary embodiment exchanges MAC-based VLAN membership information between switches; therefore, all source learning function's VLAN configurations should be consistent across switches. The source learning function's VLAN information exchanged can reflect information not active in any particular switch. For instance, VLANs may be configured but may not necessarily be active if there are no endstations active in that VLAN.

When VLAN is used in the network, the VLAN may not extend to a certain portion of the network. Devices that use port or MAC policies may or may not be known across the backplane. Port policies may be used to interconnect switches across a backbone, but this would be highly undesirable, due to the very nature of the port policies. Port policies classify all MAC stations on a specified port into one or more VLANs. When using port policies, all devices learned through that port becomes a member of the VLAN. This is very inefficient across backbones; therefore when interconnecting switch ports, port policies should not be used to define VLANs associated with the source learning function.

Port policies may be applied to establish connectivity to silent devices, such as printers. If a user needs access to a silent printer, VAP will advertise connectivity across switches to provide accessibility. Silent devices may use port or MAC policies when defining their VLAN membership, and again, device access can be advertised by VAP.

The source learning function may flood the first frame of an unknown source MAC. Flooding allows devices to find connectivity to other devices, and VLAN membership to be learned by switches.

Without VAP, loss of connectivity could occur. This is possible when one or more devices in the network times out, the VLAN flooding domain is reduced to not include once included switches. In a network without VAP, there may not be a way to recover the lost connectivity unless a device starts communicating again. VAP may allow all switches to learn that other switches have devices in common VLANs, so proper flooding and connectivity can occur.

The source learning function may internally store VLAN membership using a 32-bit mask. Therefore, the exchange of information may include the MAC address, the 32-bit mask, and the Group identifier.

The VAP in the exemplary embodiment includes a Group Mobility Advertisement component to VAP. With this component, a group is viewed as a VLAN, therefore policies are applied at the group level. Users may connect to Ethernet Ports configured for Group Mobility.

An endstation that is a member of more than one VLAN is maintained internally by specifying the MAC address, the VLAN membership number, and the protocol type. Group Mobility provides closed user VLANs. For example, if an endstation is running IP and IPX, and the switch is configured for an IP and IPX VLAN, then on a frame by frame basis the switch will forward IP frames to the IP VLAN, and IPX frames to the IPX VLAN.

Group Mobility may operate on a different premise in that they do not forward unknown sources across backbone networks. Further, each frame may be a member of one VLAN only. VLANs may be dynamically mapped to inbound Ethernet or token ring interfaces. On the other hand, VLANs are statically configured across backbone networks, so in this exemplary embodiment using VAP, the VLANs and VLAN membership are not dynamic provisioned (and are statically provisioned) across the backbone networks. VAP accelerates the learning process, so if a new destination is needed to be reached, flooding does not need to occur, instead the information is already learned on the connectivity.

Each switch in an exemplary embodiment may maintain a source learning related database, which is built up by the configured source learning policies and observed traffic. VAP may read the source learning database within the switch and may advertise these entries to other switches. In addition, VAP may generate advertisement frames on regular intervals and may transmit the protocol over the switched network (e.g., backbone network) with all new entries that the switch has learned.

When VAP receives an update from an adjacent switch containing one or more MACs that the local switch has also learned, those MAC entries may not be advertised back to the originating adjacent switch.

While the source learning function is inspecting traffic regularly, VAP is exchanging information. If a port policy is configured across a backbone, and VAP learns that a MAC is a member of an additional VLAN, the more specific VLAN membership may prevail. Further, VAP may advertise MACs to reduce flooding.

In the exemplary VAP, the learned entries may be remembered, so when the station is plugged into a new switch port, the old VLAN memberships may be reinstated. In the case of port rules, the movement may cause a station to be a member of a new VLAN.

Therefore, in the exemplary embodiment according to the present invention, when hosts (e.g., MAC stations) move, learning can be propagated relatively quickly. For example, if a host moves from one switch to another, the new switch can advertise the move and the old switch may learn of the move quicker and will not go through the full time out period (e.g., 5 minutes). Hence connectivity speed improves (i.e., becomes faster) after a move.

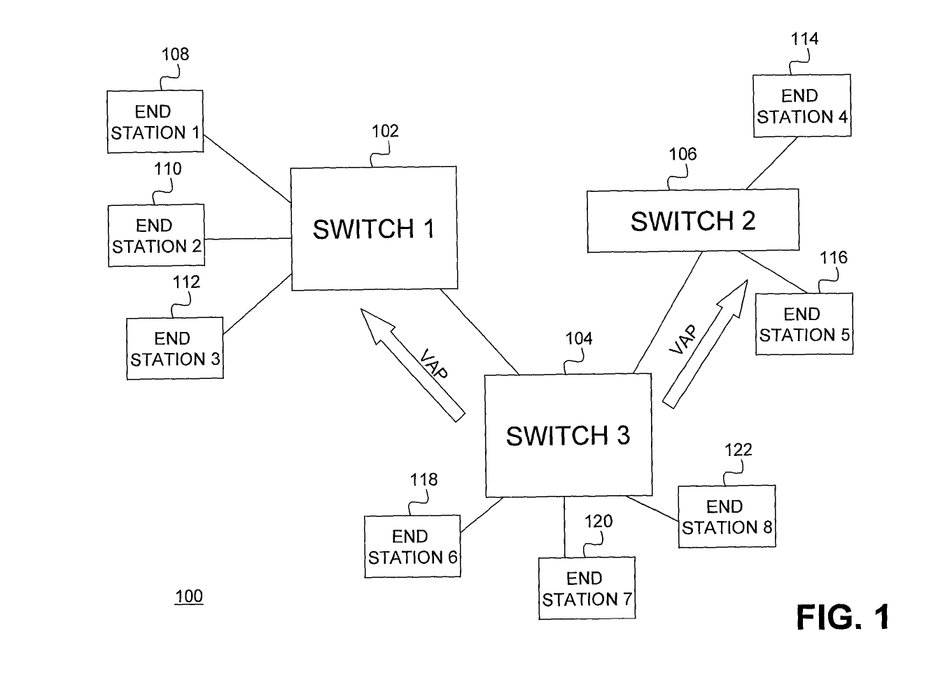

FIG. 1 illustrates a communication network 100, which may implement an exemplary embodiment according to the present invention. Switch 1 (102) and switch 2 (106) have endstations 1, 2, 3 (108, 110, 112) and endstations 4, 5 (114, 116) coupled thereto, respectively. When endstations 6, 7, 8 (118, 120, 122) are moved to switch 3 (104), the entries in the VLAN membership tables may be remembered, and old VLAN memberships may be reinstated.

In other embodiments, if a station moves, then any learned entries, either from the traffic or from VAP updates, as well as the VLAN membership may be forgotten and relearned after the move.

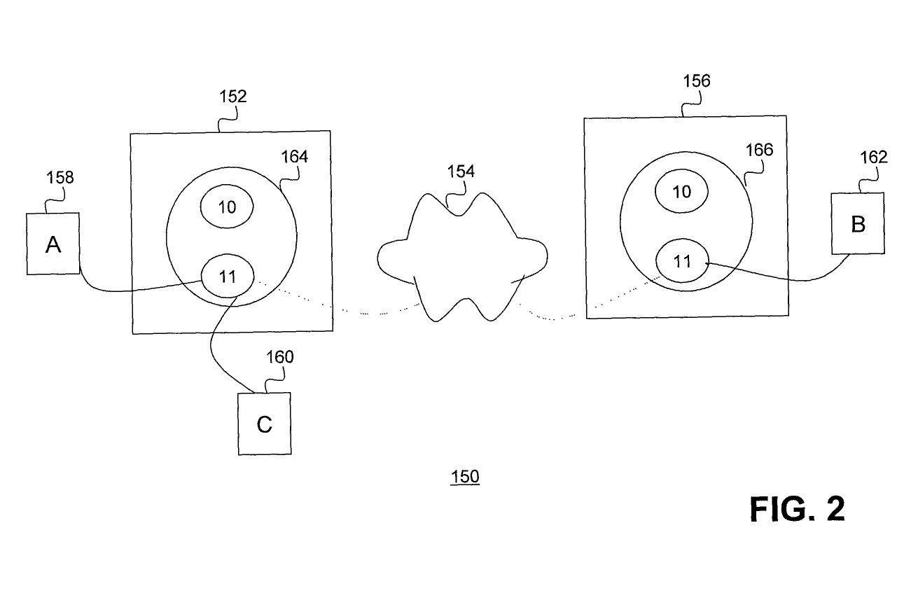

VLANs may be created dynamically on local switches separated by a backbone using VAP. FIG. 2 illustrates a communication network 150. Switches 152 and 156 are interconnected over a network 154. The switches 152 and 156 include VLAN membership tables 164 and 166, respectively. Endstations A, C (158, 160), belonging to VLAN 11, are coupled to the switch 152. An endstation B, also belonging to VLAN 11, is coupled to the switch 156.

VAP may dynamically link VLAN 11 between the switches 152 and 156, which may otherwise be disjoint. The VLAN link between the switches 152 and 156 may be dynamically created and then removed.

For illustrative purposes only, the communication network 150 includes only two switches, each having two VLAN memberships in its VLAN membership database. In practice, there may be multiple other switches, each having additional number of VLAN memberships. Further, each switch may have multiple other endstations coupled thereto.

A typical way to ensure that connectivity is established and maintained across a common backbone is to use port policies. The disadvantage of using port policies for this connectivity is that every frame received from any device on that port will become a member of all VLANs using port policies. This may be very inefficient.

VAP may eliminate the need for port rules applied to backbones. VAP advertises learned MAC devices and their VLAN memberships to other switches. This may lead to a system where only devices that really need to be in a VLAN are in that VLAN. VAP may ensure that frames that need to be forwarded are the only frames forwarded across a backbone.

Auto discovery may be used by a Network Management Station (NMS) to learn about the existence of switches, as well as the physical topology interconnecting them. VAP may include the IP address of virtual router ports configured within an originating switch. VAP may not be forwarded through routers; instead, the VAP updates may remain local to a switched network.

VAP also may include a Management Advertisement Protocol (MAP), which provides mechanisms to learn connectivity topology, which is an indication of which ports are connected to which other ports.

For example, using MAP in this embodiment, adjacencies of a switch may be discovered. Further, the switch would send out and receive hello messages to and from other switches. The switch may advertise its identity and learn identities of other switches and network devices, such as, for example, in a form of IP addresses and port on the switch that frame (e.g., hello message) was transmitted on.

With information collected from hello messages and/or other messages, a table may be built. Tables that are built from MAP can be accessed from NMSs outside the switch. Thus, using information from other switches and NMSs, a topology map may be created.

For example, when one switch is reachable through more than one physical port, MAP provides learning that multiple IP addresses are in fact on switch with two different addressable interfaces. Thus, MAP in this embodiment may be used as a discovery mechanism, for example, to realize that two different ports with two different IP addresses are on a single switch.

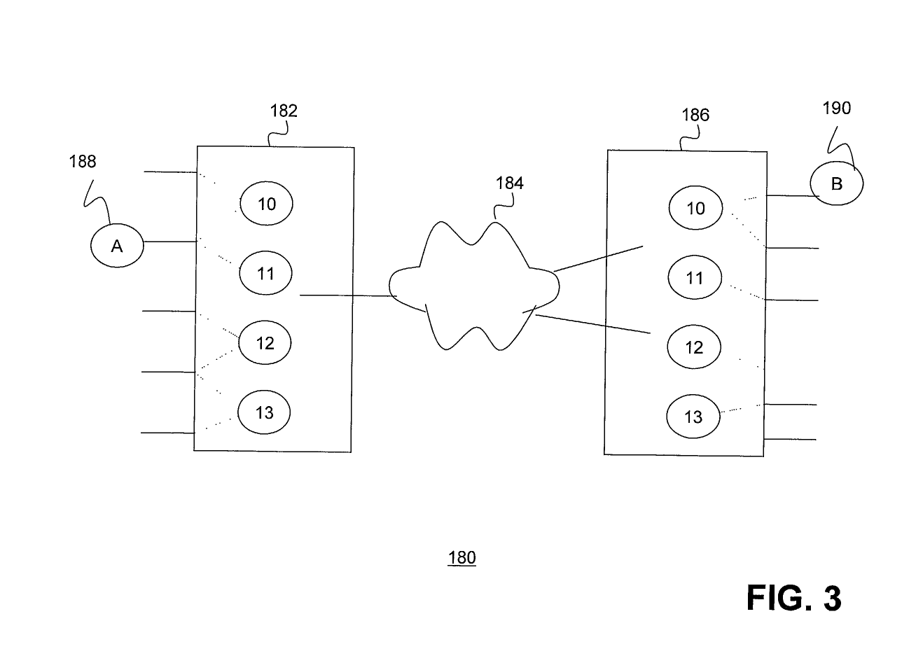

FIG. 3 illustrates a communication network 180, which may be used to implement VAP in this embodiment. Switches 182 and 186 are interconnected over a network 184. The VLAN links between these two switches may be statically provisioned. Each of the switches have VLANs 10, 11, 12 and 13 on their respective VLAN membership tables. An endstation A (188) is coupled to the switch 182, and the endstation B (190) is coupled to the switch 186.

When an endstation sends a frame to the coupled switch, a policy match is performed and the endstation is placed in a VLAN. Thus, those ports may be mapped to the VLAN dynamically based on traffic patterns. However, the VLANs and VLAN membership are statically provisioned through the backbone ports of the network 184. Across these backbone ports, the switches 182 and 186 advertise the maps on the edges to each other.

In FIG. 3, the VLANs may comprise closed user group VLANs with a definite, closed set of users. VAP in this embodiment may have certain mobile ports that are not statically configured. These ports may be considered as leaf ports on a spanning tree at the edge of the network. The ports (e.g., on switches) that are connected to the core of the network are statically provisioned, and are used to exchange information for group mobility.

For illustrative purposes only, the communication network 180 includes only two switches, each having four VLAN memberships in its VLAN membership database. In practice, there may be multiple other switches, each having additional number of VLAN memberships. Further, each switch may have multiple other endstations coupled thereto.

VAP, MAP and GMAP may be combined into a single protocol in other embodiments. Further, their names may be different in other embodiments.

Table 1 illustrates VAP characteristics, such as, for example, database entries, transmission rates and packet sizes, in an exemplary embodiment according to the present invention. In other embodiments, these VAP characteristics may be different.

TABLE 1
VAP Characteristics

| | |
|---|---|
| Bridge Filter Table | 16 K maximum entries (32K in the |
| | future) |
| VAP Database Entries | 40K Maximum |
| VAP Adjacency Database | 2000 Maximum |
| VAP Transmission Rate | Every 20 seconds (version 1) |
| | Every 5 minutes after |
| | stabilization (version 2 only) |
| Maximum VAP Packet Size | 1492 Bytes |

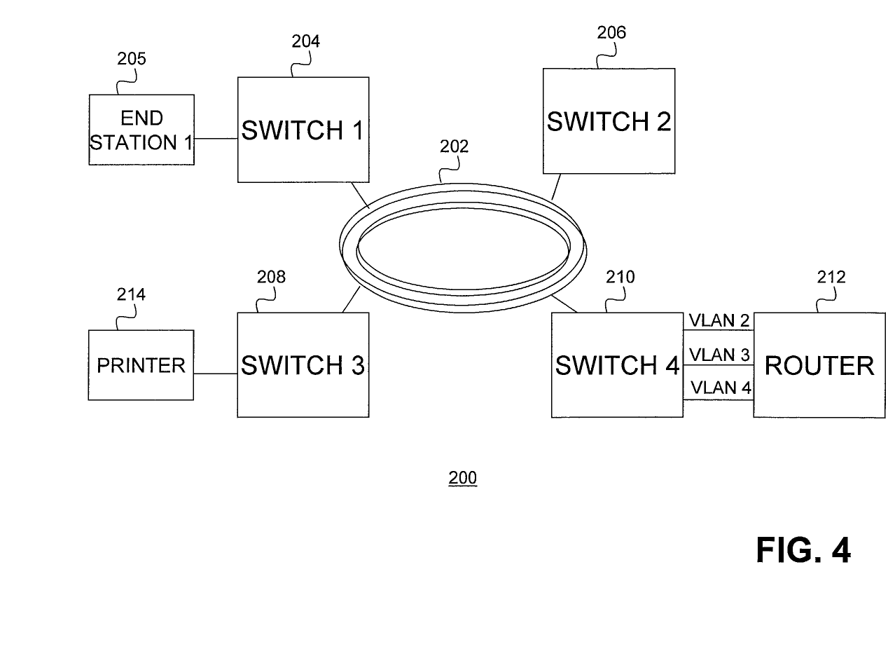

FIG. 4 illustrates a network 200, in which four switches 1, 2, 3, 4 (204, 206, 208, 210) are interconnected over an FDDI backbone 202. A printer 214, which is a part of VLAN 10 and which may be a silent printer, is coupled to the switch 3 (208). Connected to the switch 4 (210) is a router 212 having three physical connections, one for each IP network VLANs 2, 3, and 4. Since the printer is silent, the printer should be explicitly configured to be a part of VLAN 10. This explicit configuration may be achieved by using a port policy, which may also ensure that the traffic will be forwarded to the printer.

However, in order for an endstation 205 coupled to the switch 1 (204) to send a file to the printer 214, both the printer 214 and the endstation 205 should be on VLAN 10. This means that the switch 1 (204) should know or have learned that the printer 214 is located across the FDDI backbone 202. If there are no other devices that are part of VLAN 10 across the backbone 202, any unknown destination MAC frames will not be flooded onto the FDDI backbone 202. To ensure that connectivity to the printer 214 occurs, a port policy may be used on the switch 1 (204).

A disadvantage of using a port policy on the backbone may be that all unicast traffic destined for the printer 214 may be flooded out all ports on all switches which are members of VLAN 10. In addition, all traffic learned through the FDDI backbone 202 may be classified as being a member of VLAN 10. This may not be desirable.

It would be more efficient to forward only the traffic destined to the printer 214 over the LAN segments needed to reach the printer 214. Also, placing a port policy on the FDDI port may force devices to unnecessarily become members of VLAN 10, resulting in additional forwarding of traffic, some of which may not be necessary.

VAP, when implemented in the communication network 200, may relay learned MACs from one switch to other switches. If a switch does not know how to reach a specific MAC address, the switch can refer to its VAP table to see if any other switch has learned that device. This may result in more efficient forwarding of traffic and may reduce unnecessary use of bandwidth.

In an exemplary embodiment according to the present invention, VAP may build the following two VAP tables: 1) a VAP MAC table; and 2) an adjacency table.

The adjacency table contains a list of the adjacent switches that the local switch has learned about. The MAC VAP table contains the MAC addresses learned, the VLAN membership mask learned, and a precedence type. The precedence types may include one or more of, but are not limited to: 1) default priority; 2) standard priority; 3) router priority; and 4) override priority.

In another exemplary embodiment according to the present invention, VAP may build the following two VAP tables: 1) a VAP MAC table; and 2) a local adjacency table.

The local adjacency table contains a list of the switches that are directly connected or one hop away from the current switch. This table may be used by NMS for auto-discovery. In order for NMS to accurately create a representation of the network, these frames should be generated by each switch and should not be forwarded through any switch.

The information exchanged and maintained may contain the following information: 1) remote VAP switch identifier; 2) slot/port/type/instance frame was received on; 3) group assigned to inbound port; and 4) source MAC of remote switch. The remote VAP switch identifier is a unique value created by the switch using the least significant 24 bits of the MAC address stored in a primary Message Processing Module's (MPM's) EEProm.

The VAP MAC table contains the MAC addresses learned with a their appropriate VLAN information. In the exemplary embodiment, depending on whether the MAC is a member of a source learning function or GMAP VLAN, the contents of the entry may be different. If the MAC is a member of a source learning function's VLAN, then the entry may contain the following: 1) MAC address; 2) Group Identifier; 3) VLAN membership mask; and 4) a precedence type field.

If the MAC is a member of GMAP VLAN, then the entry may contain the following: 1) MAC address; 2) Group Identifier; 3) Protocol Field <list possibilities for this field>; and 4) a precedence type field.

The precedence types may include one or more of, but are not limited to: 1) default priority; 2) standard priority; 3) router priority; and 4) override priority. Entries marked with a default priority may not be advertised by VAP. The switch may remember the port the VAP frame was received on in order to map endstations defined in the VAP update to a switch port for further forwarding. Entries marked with an override priority may result in forced forwarding of frames associated with that entry. In the exemplary embodiment, where Group Mobility is used, policies may be applied with a precedence policy.

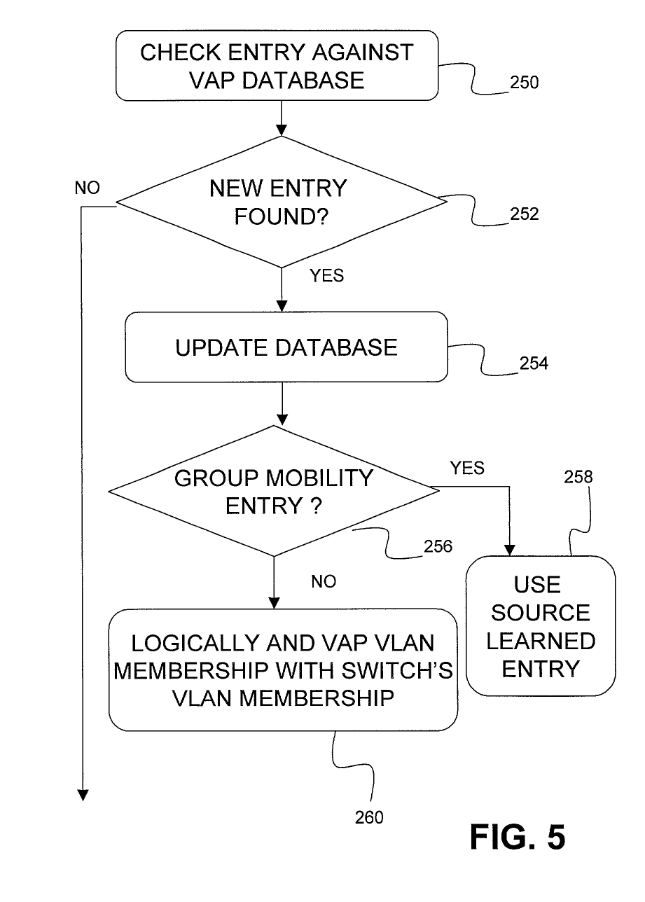

FIG. 5 is a flow diagram illustrating process of processing VAP updates in an exemplary embodiment according to the present invention. In step 250, when VAP updates are received from other switches, each entry in the VAP message is checked against the VAP database. If new entries are received as determined in step 252, the database is updated in step 254. In addition, a background process may periodically run and compare the VAP database to a forwarding database.

There is a field in each entry identifying whether it is a source learning function entry or a Group Mobility entry. If the entry is a Group Mobility entry as determined in step 256, the entry used is the one learned, which is the MAC/VLAN association. If however, the entry is associated with the source learning function, the VAP VLAN membership and the switch's VLAN membership are logically AND'ed together to generate a complete VLAN membership in step 260.

The forwarding database of a switch may have a variety of information in it. Below is some of the information, which may be used for VAP processing: 1) MAC Address; 2) VLAN Mask for source learning function entries; 3) Protocol Field for GMAP entries; 4) Group Identifier; and 5) Source Virtual Port.

In VAP, one frame format packet type may be provided. This may be a source learning function version of VAP. The frames may be transmitted on regular intervals out all bridged interfaces. Table 2 illustrates a VAP frame format in this source learning function version of VAP.

TABLE 2
VAP Packet Header and Report Frame

| | | | |
|---|---|---|---|
| 0 | 1 | 2 | 3 |
| 0 1 2 3 4 5 6 7 | 0 1 2 3 4 5 6 7 | 0 1 2 3 4 5 6 7 | 0 1 2 3 4 5 6 7 |

VAP Header

| | | | |
|---|---|---|---|
| Version | Type Field | Total Entries | No. of Groups |

| | |
|---|---|
| Port Group ID | Reserved |

Host ID 1 (IP address 1)
Host ID 2 (IP address 2)
Group Header

| | |
|---|---|
| Group ID | Number of Entries |

Active VLANs Mask
VAP Entry
MAC Address

| | |
|---|---|
| MAC Address (Cont.) | Precedence Flag |

VLAN mask
Next Entry

The header portion is present in every VAP packet. The field definitions for the header are as follows:

1) Version—If Version equals 1, then process as a source learning function version; if Version equals 2, then process as VAP in the exemplary embodiment.

2) Type Field—For Version equals 1, command of 1 is defined as Report Type.

3) Total Entries—The total number of entries present.

4) Number of Groups—The number of Group information sections present.

5) Port group ID—The group ID of the sending port.

6) Reserved—Reserved for later use.

7) Host ID 1—This identifies the sending host. It usually is an IP address.

8) Host ID 2—Another IP Address (may be zero if none)

Each Port group has a separate section in the messages that starts with a group header. The field definition for the group header is: 1) Group ID—The port group identification number; 2) Number of Entries—The number of VAP entries that follow which are in the group; and 3) Active VLANs mask—A bit array showing the VLANs that are active in this group.

Each MAC/VLAN pairing is defined in a VAP entry. The fields of a VAP entry are as follows:

1) MAC address—The MAC address of the host unit that is being mapped to a VLAN.

2) VLAN mask—A bit mask indicating which of any 16 VLANs in this group that the host is a member of.

3) Precedence flags—This number indicates the precedence of this mapping. This number is an indication of the certainty of the mapping. For example, if the mapping was learned from a packet that was clearly sent from a router, the precedence would be higher than if the packets source was not certain to have been a router. A statically allocated MAC/VLAN may have the highest precedence, for example.

The precedence values are defined as follows:

a) 0—Default precedence—Pairing was a default pairing, perhaps by configuration.

b) 1—Standard precedence—Pairing was obtained through a standard rules match.

c) 2—Router precedence—Pairing was verified to be a router port.

d) 3—Override precedence—Pairing was set by configuration to be unalterable. Switches should always use the highest precedence information available.

The messages may have the same format at all times, a packet header followed by a group header, a number of VAP entries pertaining to that group, followed by a group header and another number of VAP entries. The packets length is the header length+(Total Entries*size of VAP entry)+(Number of Groups*size of Group Header).

The maximum size of a single VAP packet may be 1492 bytes. This can be made up of any combination of Group headers and VAP entries. The maximum number of entries lies between 74 and 123 depending on how many port groups are represented in that packet. Of course, in embodiments of the present invention, the maximum size of a single VAP packet may be more or less than 1492 bytes, and the maximum number of entries may be different.

As many packets as necessary may be sent to complete an update. No special provisions may be made for continuation since each packet can be processed individually. Since spanning tree prevents loops, no provision is made to detect packet duplication. This would not cause a problem if it occurred other than the additional time consumed processing a duplicate packet. In the event that a switch receives a packet which it generated (as indicated by the source MAC address), the switch may discard the packet.

In an exemplary embodiment according to the present invention, two frame formats are provided. For example, this embodiment has Hello messages and forwarding database updates as frame format packet types.

The Hello messages are simple messages used to notify other switches of existing adjacent equipment. These frames may not be bridged through the switch, but may instead be generated and received as endstation frames. These frames may be used to build a valid adjacency table. The adjacency table may be used for Network Management discovery and graphic recreation of connectivity between switches. Table 3 illustrates a Hello message frame format in this embodiment:

TABLE 3
VAP Hello Packet Header and Entries

| | | | |
|---|---|---|---|
| 0 | 1 | 2 | 3 |
| 0 1 2 3 4 5 6 7 | 0 1 2 3 4 5 6 7 | 0 1 2 3 4 5 6 7 | 0 1 2 3 4 5 6 7 |

VAP Header

| | | | |
|---|---|---|---|
| Version | Type Field | Total Entries | Source Switch ID |

| | |
|---|---|
| Source Switch ID (Cent.) | Primary Port Group ID |

Router Entries
Host ID 1 (IP address 1)
Host ID 2 (IP address 2)

The VAP header and the Router Entries are required for this type of frame. The field definitions are as follows:

1) Version—If Version equals 1, then process as source learning function version; if Version equals 2, then process as VAP in the exemplary embodiment of the present invention.

2) Type Field—In the exemplary embodiment, there are two message types. One is the Hello message used to create the adjacency table, and the other is the Forwarding table update frame. It should be noted that these frame formats are different from the above-discussed source learning function version frame format.

3) Total Entries—The total number of Router entries present. This field will be set to 0 if this is a Hello message.

4) Originating Switch Identifier—This is the Switch Identifier of the sending switch.

5) Port group Id—The group id of the sending port of the sending switch.

6) Host ID 1—This identifies the sending host, which usually is an IP address, but may also include a MAC address.

7) Host ID 2—Another IP Address (may be zero if none).

In this embodiment, there are no VAP entries included in the Hello message.

The source switch identifier is used to determine unique switches for the adjacency table. It is 24 bits in length and is the lower 24 bits of the first MAC address assigned to the primary MPM. These frames may not be bridged through the switch. They may be received by the MPM and not forwarded.

In the case where loops exist within a group, Hello messages may be transmitted on ports regardless of spanning Tree state for a particular port. This may allow Network Management to accurately graph the network topology, and clearly identify individual switches. This may be different from the forwarding table update messages, which may only be sent on ports that are in a forwarding state.

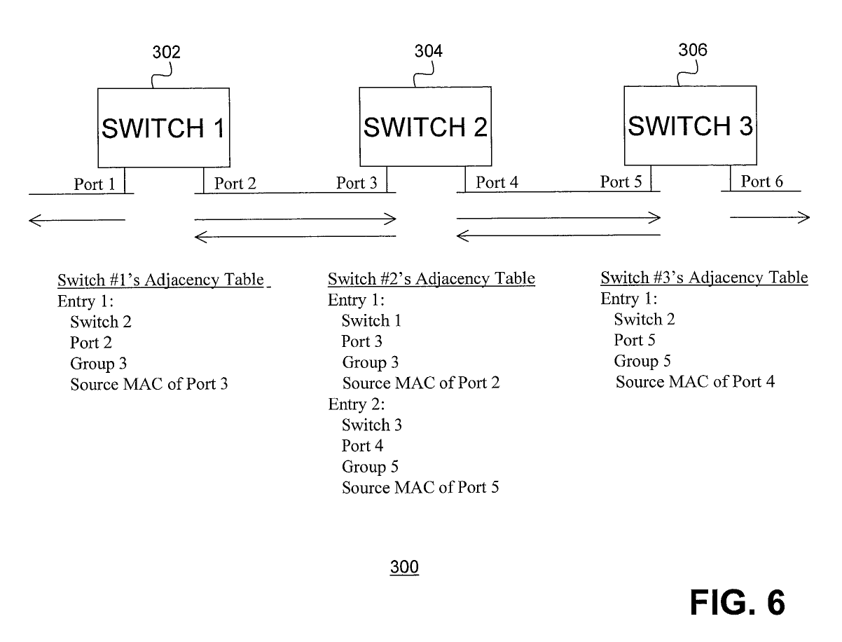

An example of using Hello Messages to build adjacency tables is illustrated on FIG. 6. Each of a switch 1 (302), a switch 2 (304) and a switch 3 (306) builds a table containing one or more entries that contains the following information for each entry: 1) switch the update was learned from; 2) port which the update was received on; 3) primary group of the port that the update was received on; and 4) source MAC of the remote switch.

Since these updates may be used for auto-discovery, for a true network picture, these frames should be transmitted on all ports. To ensure that the network does not get flooded with these updates, all switches may not forward this type of frame. In the event that a switch receives a packet which it generated, (as indicated by the source MAC address) the switch discards the packet.

There is a second frame for the exemplary embodiment of VAP, which may be bridged throughout the network to update switches of MAC stations, learned by that switch. This frame is forwarded out on only non-leaf ports and the default is every 30 seconds for transmission of this frame.

Table 3 illustrates a VAP forwarding database update frame format in this embodiment according to the present invention

TABLE 4
VAP Packet Header and Entries

| | | | |
|---|---|---|---|
| 0 | 1 | 2 | 3 |
| 0 1 2 3 4 5 6 7 | 0 1 2 3 4 5 6 7 | 0 1 2 3 4 5 6 7 | 0 1 2 3 4 5 6 7 |

VAP Header

| | | | |
|---|---|---|---|
| Version | Type Field | Total Entries | Source Switch ID |

| | |
|---|---|
| Source Switch ID (Cont.) | Primary Port Group ID |

VAP Entry
MAC Address

| | | |
|---|---|---|
| MAC Address (Cont.) | # of Groups | Reserved |

Group Entry

| | |
|---|---|
| Group ID (1^{st}) | Reserved |

Flags Field
Active VLANs Mask or Protocol Field
Group Entry

| | |
|---|---|
| Group ID (N^{th}) | Reserved |

Flags Field
Active VLANs Mask or Protocol Field
Next Entry

In the described exemplary embodiment, the VAP header portion is present in every VAP, and the field definitions are as follows:

1) Version—If Version equals 1, then process as a source learning function version of VAP; if Version equals 2, then process as VAP in the exemplary embodiment.

2) Type Field—For the exemplary embodiment, there are two message types. One is the Hello message used to create the adjacency table, and the other is the Forwarding table update frame. It should be noted that these frame formats are different from the source learning function version frame format.

3) Total Entries—The total number of MAC entries present. This field will be set to 0 if this is a Hello message.

4) Originating Switch Identifier—This is the Switch Identifier of the sending switch.

5) Port group Id—The group id of the sending port of the sending switch.

6) Reserved—Reserved for later use.

Each VAP Entry is listed consecutively following the VAP header in this embodiment. A VAP entry can contain multiple group entries for each MAC. The definition for each VAP entry is an independent entry and is as follows:

1) MAC address—The MAC address of the host unit that is being mapped to a VLAN.

2) Total number of Groups—The total number of Groups that the MAC is a member of. This value represents the number of Group entries within this VAP entry and indicates whether this is a source learning function entry or a GMAP entry. If the value is 0, it signifies a source learning function version entry. If the value is non-zero, it is a GMAP entry.

3) Reserved—reserved for future use

4) Group Identifier—The Group Identifier for the following Precedence field and VLAN Mask or Protocol field

5) Reserved field

6) Flags Field (32 bits total)

a) AT Flags (16 bits)—Source learning function Flags

b) Router Flags (16 bits)—Router Flags indicate whether this entry is a router or not. Router MACs require special handling.

7) VLAN mask or Protocol field—A bit mask indicating which of any 32 VLANs in this group that the host is a member of. Or if this is a GMAP entry, it represents the protocol type of this entry.

In this embodiment, there can be multiple Group entries within a VAP entry. Further, the packets length in this embodiment is the header length+((Total Entries*size of VAP header)+(Number of Group entries for each VAP entry*size of Group entry)). The maximum size of a single VAP packet is 1492 bytes in this embodiment. The maximum size may be different in other embodiments.

As many packets as necessary may be sent to complete an update. No special provisions may be made for continuation since each packet can be processed individually. Since spanning tree prevents loops, no provision is made to detect packet duplication. (This may not cause a problem if it occurred, other than the additional time consumed processing a duplicate packet). In the event that a switch receives a packet which it generated, (e.g., as indicated by the source MAC address) the switch may discard the packet.

In an exemplary embodiment according to the present invention, the switch may send a complete list of VAP entries, which have been determined to exist by the switch, every 30 seconds. A 60 second timer may be jittered by a small random number not to exceed 15 seconds in order to avoid synchronization with other switches.

If more than one packet are to be sent, the switch may leave a gap of at least 8/60 (1/60 of a second is the internal tick time of an exemplary switch.) of a second between packets. Information, which is received but not refreshed within 6 to 60 second timeout, may be discarded. Update packets may not be sent if the switch port is in an unsettled state after a topology change. The 60 second update may not be sent out of that port.

These timing numbers may allow sending of 40000 entries in one 60 second period (assuming that each packet contains 100 entries).

In another exemplary embodiment according to the present invention, Hello messages may be propagated every 30 seconds. The Forwarding Table Update messages may initially be transmitted every 30 seconds for the first 5 minutes, the every 15 minutes thereafter. The default may, for example, b set to 15 minutes and VAP entries may have a default-aging timer of 72 hours. All of these values may be tunable by a configuration parameter.

During an advertisement interval, the switch may send a complete list of VAP entries, which have been determined to exist. A 60-second timer may be jittered by a small random number not to exceed 15 seconds in order to avoid synchronization with other switches. These entries may only be transmitted on non-leaf ports. This, for example, may include non-leaf ports running 802.1Q as a backbone trunking protocol. It should be noted that these frames may not be propagated on ports with Authenticated VLANs active, or propagate any information on MAC stations participating in Authenticated VLANs.

If more than one packet is to be sent, the switch may leave a gap of at least 2/15^{th}, of a second between packets.

Information, which is received but not refreshed within a 6 to 60 second interval, may be discarded. After a topology change, update packets may not be sent if the switch port is in an unsettled state after a topology change. The 60-second update may not be sent out of that port.

There may also be triggered updates for MAC stations that change groups for the same protocol within the same switch.

When a station moves and has not been rebooted, some protocols may not transmit frames; therefore, VAP, upon detecting a new station, may check the VAP database to see if it was a member of any VLAN. If it was, it may first use the current frame to determine the correct VLAN membership and may instantiate any other VLANs for any other protocols it may have previously been a member of.

In an exemplary embodiment according to the present invention, output processing is engaged at each VAP send table interval time. The switch may examine all entries in the Forwarding database and construct a single VAP message in memory. If the message is less than the maximum message size then it may be sent out of all interfaces, which have either received spanning tree frames or incoming VAP frames.

If the message is greater than the maximum size, the switch may build the first outgoing message and send it. It may then start a gapping process which may be used to send the rest of the information in separate packets with a 2/15^{ths} of a second gap between the packets.

In this embodiment, the first three time periods after initialization, VAP packets may be sent out of all configured active ports. After this initial period, the VAP packets may only be sent on non-leaf ports.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by the appended claims and their equivalents.

I claim:

1. A communication network comprising:
at least two switches, each switch being capable of maintaining a database of VLAN membership;
a backbone network interconnecting the switches; and
at least one network node coupled to at least one of the switches,
wherein the VLAN membership databases in said at least two switches are synchronized with one another.

2. The communication network according to claim 1, wherein VLANs and the VLAN membership are dynamically provisioned across the backbone network.

3. The communication network according to claim 1, wherein VLANs and the VLAN membership are statically provisioned across the backbone network.

4. The communication network according to claim 1, wherein when coupling of said at least one network node is moved from a first switch to a second switch, the second switch is capable of advertising the move.

5. The communication network according to claim 4, wherein the first switch is capable of learning of the move, whereby the first switch does not go through a full time out period.

6. The communication network according to claim 1, wherein a protocol between said at least two switches has topology discovery capability.

7. The communication network according to claim 6, wherein the topology discovery capability comprises a capability to learn topology connectivity as to which port is connect to which other port.

8. The communication network according to claim 6, wherein the topology discovery capability comprises a capability to learn topology connectivity of at least one selected from a group consisting of IP addresses, MACs and VLANs.

9. The communication network according to claim 1, wherein when a second switch is reachable through a plurality of IP addresses by a first switch, the first switch is capable of learning that the IP addresses are on the second switch with a plurality of addressable interfaces, each addressable interface corresponding to one of the IP addresses.

10. The communication network according to claim 1, wherein the VLAN membership is determined by applying at least one policy with precedence policy to a specific traffic.

11. The communication network according to claim 1, wherein at least one switch is capable of automatically discovering network nodes in the network.

12. The communication network according to claim 1, wherein at least one switch advertises connectivity of at least one network node across at least a portion of the backbone network.

13. The communication network according to claim 1, wherein a network node is moved from a first port to a second, and wherein the learned entries and a VLAN membership for the network node are remembered.

14. The communication network according to claim 13, wherein a first switch includes the first port and a second switch includes the second port.

15. A communication network comprising:
at least two switches, each switch being capable of maintaining a MAC table;
a backbone network interconnecting the switches; and
at least one network node coupled to at least one of the switches,
wherein said at least two switches exchange MAC information, wherein at least one switch uses the MAC information from at least one other switch to update its MAC table.

16. The communication network according to claim 15, wherein at least one switch generates a frame that contains a unique ID.

17. The communication network according to claim 15, wherein at least one switch builds an adjacency table.

18. The communication network according to claim 15, wherein at least one switch advertises its VLAN membership information.

19. The communication network according to claim 15, wherein at least one switch generates a frame that includes a list of at least one virtual router port in that switch.

20. The communication network according to claim 15, wherein a rapid aging of MAC takes place based on VLAN updates in at least one switch.

21. A method of updating a VLAN database, the method comprising:
transmitting at least one update message from a first switch;
receiving said at least one update message at a second switch;
checking at least one entry in said at least one update message against the VLAN database in the second switch; and
if a new entry is found, updating the VLAN database with the new entry.

22. The method according to claim 21, further comprising automatically discovering at least one network node.
